(19) United States
(12) Patent Application Publication
(10) Pub. No.: US 2006/0017684 A1
(43) Pub. Date: Jan. 26, 2006

(54) Display driver and driving method reducing amount of data transferred to display driver

(75) Inventor: David Andrew Fish, West Sussex (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILLIPS ELECTRONICS N.V.

(21) Appl. No.: 10/507,948

(22) PCT Filed: Feb. 6, 2003
(86) PCT No.: PCT/IB03/00402

§ 371 Date: Sep. 14, 2004

(51) Int. Cl. G09G 3/36

(52) U.S. Cl. 345/100

(57) ABSTRACT

A column driver (16) includes a basis function generator (32) internally within the column driver (16), and combination units (34) for combining the outputs of the basis function generator with coded transform image data input on input (28). Accumulator (36) accumulates decoded image data and driver circuitry (22), (24), (26) drives the columns of the display.

The invention relates to displays and in particular to methods of driving matrix type displays and the corresponding displays.

Matrix type displays, for example liquid crystal displays or arrays of light emitting diodes (e.g. OLEDs or PLEDs), are used in a wide variety of applications. These include in particular portable applications such as mobile telephones, electronic books and laptops powered by batteries.

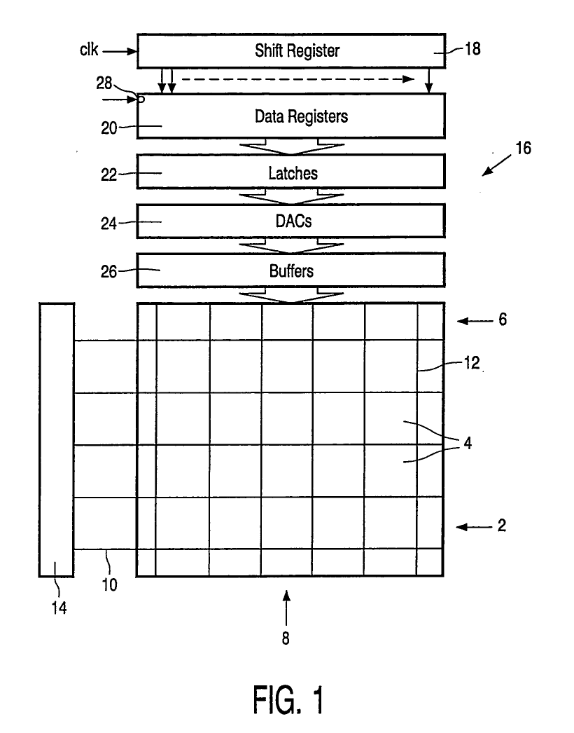

FIG. 1 illustrates a conventional display having an active matrix plate 2 with a plurality of pixels 4 arranged as rows 6 and columns 8. Row lines 10 run along the rows of pixels, and column lines 12 run along the columns of pixels. The row lines 10 are connected to a row driver 14 and the column lines 12 to a column driver 16.

The column driver 16 includes a shift register 18, connected to data registers 20, latches 22, digital-to-analogue converters 24 and buffers 26. Data flows from the data registers to the column lines 12 of the columns in parallel as will now be described. The shift register 18 is clocked and data is supplied from input 28 into the data register specified by the output of the shift register. Conventionally, there will be one data register per column.

Once the data registers for all of the columns of one of the rows of the display are filled, the latches 22 are clocked so that the data stored in the data register is output to the digital-to-analogue converters 24 in parallel. These convert the digital column signals stored in the data registers to an analogue voltage which is passed through a voltage buffer 26 which actually drives the display columns. The row driver 14 selects one of the rows 6 by driving corresponding row line 10 to display the output of the buffers. This procedure is then repeated for other rows 6 selected by row driver 14 to build up the complete image. As will be noted, the amount of data required to be brought into the data registers 20 is very large, since every frame requires a piece of data for each pixel in every row and column.

As display resolution increases the rate at which data needs to be transferred to the display increases. This consumes greater power and causes electromagnetic interference problems. Although increased power drain is an issue in all devices, it is particularly important for battery powered devices.

There is accordingly a need to address the problem of delivering increased data rates to displays.

The skilled practitioner will be familiar with prior techniques for coding and decoding compressed image data. For example, the facsimile transmission standard of the CCITT (Comite Consultatif International de Telephonie et Telegraphie) for Group 3 facsimile transmission uses compressed data. One commonly used technique for data compression is to convert the data to a transform domain, e.g. a Fourier domain, in which many of the transform coefficients become zero or near zero. Many compression standards rely on such transforms on 8×8 blocks of data, including the JPEG and the MPEG standards.

However, the prior art approaches for decompressing data of which the applicants are aware involve decompressing the data first, for example using a computer, and then transmitting the data to drive the display. In addition, decompressed data may be stored in a frame store before transmitting the data to a display, requiring a significant amount of storage for large displays. Thus, these prior data compression techniques do not reduce the amount of data supplied to the column driver.

It should be noted that in the present specification the term “row” is used to describe the direction on the matrix display which the lines of input data address, and “column” describes the direction of the lines driven in parallel by the decoder without implying any particular arrangement or orientation of the display.

According to the invention, there is provided a column driver for driving a plurality of columns of a display with rows of image data for output on corresponding rows of the display, the column driver comprising: a basis function generator for generating sets of basis function values and for outputting in parallel a selected set of basis function values for respective columns; an input for accepting rows of coded transform image data, each row including at least one item of coded transform data; a plurality of combination units operative to combine the generated set of basis function values for the respective columns with a corresponding input item of coded transform data; an accumulator associated with each of the columns for accumulating for each row of coded transform image data the data combined by the respective combination unit for each item of coded transform data in turn to accumulate decoded data for the respective column; and driver circuitry for driving the column lines of the display with the accumulated decoded data for the respective columns to drive a row of the display.

In other words, the column driver according to the invention includes a basis function generator which outputs basis function values in parallel for the columns. This allows data coded in a transform domain to be decoded in parallel within the column driver itself. This reduces the rate that data needs to be delivered to the column driver, which can reduce the power radiated from the drive lines.

The invention may be used with a number of different types of coded data. For example, the column driver may be used with data coded with transforms such as the digital Fourier transform and the Cosine or Sine transform. The combination unit may be a multiplier for multiplying the basis function value with the coded transform data. The multiplier may be provided for each column in order to allow the multiplication to be carried out in parallel.

Embodiments of the invention may decode data coded using the Cosine transform which has been determined to give excellent results in display applications.

Alternatively, the column driver may decode data encoded using a transform in which the basis function values take only binary values, such as the Walsh or the Haar transform. In this case, a multiplier is not required and the combination unit may pass the transform data directly when the basis function value takes one binary value and pass the transform data after inversion when the basis function value takes the other binary value.

In embodiments, exactly one accumulator and one combination unit may be provided for each column. This provides a simple architecture. It may also be possible to combine one or both of the accumulator and combination unit for several adjacent lines. For example, a 64 bit accumulator may include eight 8 bit data values corresponding to 8 columns. In this case, it may be useful to design the accumulator to avoid carrying data across from the bits used to represent one column line to the data used to represent another column line. Alternatively or additionally, dummy or guard bits may be provided to separate data corresponding to different column lines.

The basis function generator may include a memory and a counter. In an alternative embodiment, the basis function generator may include a logic circuit associated with each of the columns, the logic circuits being connected to a common data rail for outputting the basis function values for each column based on data supplied on the common data rail. The logic circuits may each have two inputs and one output. One of the inputs of each logic circuit may be hard-wired to a different constant for each column. The other input of each logic circuit may be connected in parallel to the common data rail for receiving a signal indexing the required basis function. The signal input may be connected to a counter.

The invention also relates to a display having such a column driver, for example a liquid crystal display, an electroluminescent display, an electrophoretic display, a plasma display, or any other type of display having rows and columns of pixels.

The invention also relates to a method of driving the columns of a display with coded transform data, each row being represented by at least one item of data, using a plurality of accumulators associated with a respective plurality of column lines, the method comprising: clearing the accumulators; generating a first set of basis data values for respective columns; combining the first set of coded transform data with the first item in parallel for the plurality of columns; accumulating the combined data in parallel in the respective accumulators; repeating for each subsequent items of data of the row the steps of inputting, generating, combining and accumulating to accumulate decoded data in the accumulator; and driving the column lines of the display with the decoded data.

Embodiments of the invention will now be described, purely by way of example, with reference to the accompanying drawings in which:

FIG. 1 illustrates a prior art column driver architecture;

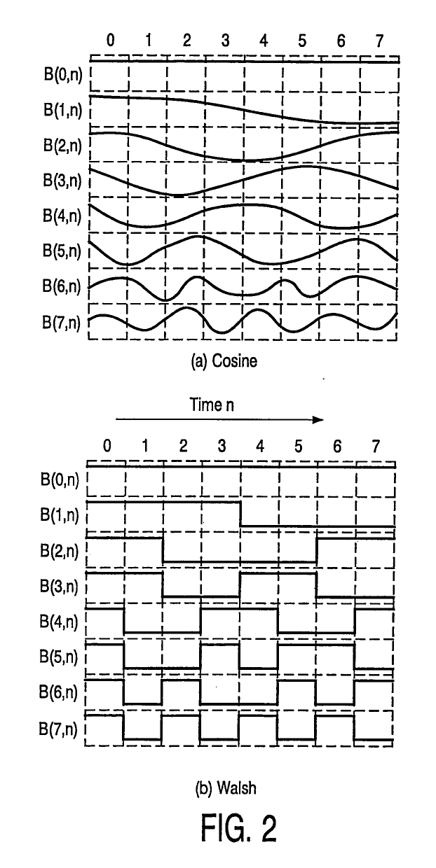

FIG. 2 illustrates example basis functions;

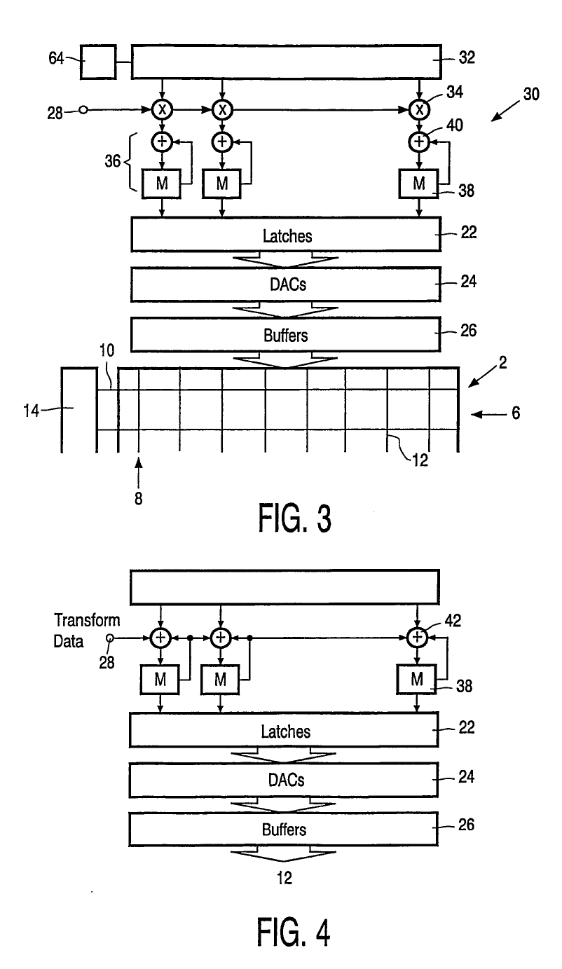

FIG. 3 illustrates a column driver according to a first embodiment of the invention;

FIG. 4 illustrates a column driver according to a second embodiment of the invention;

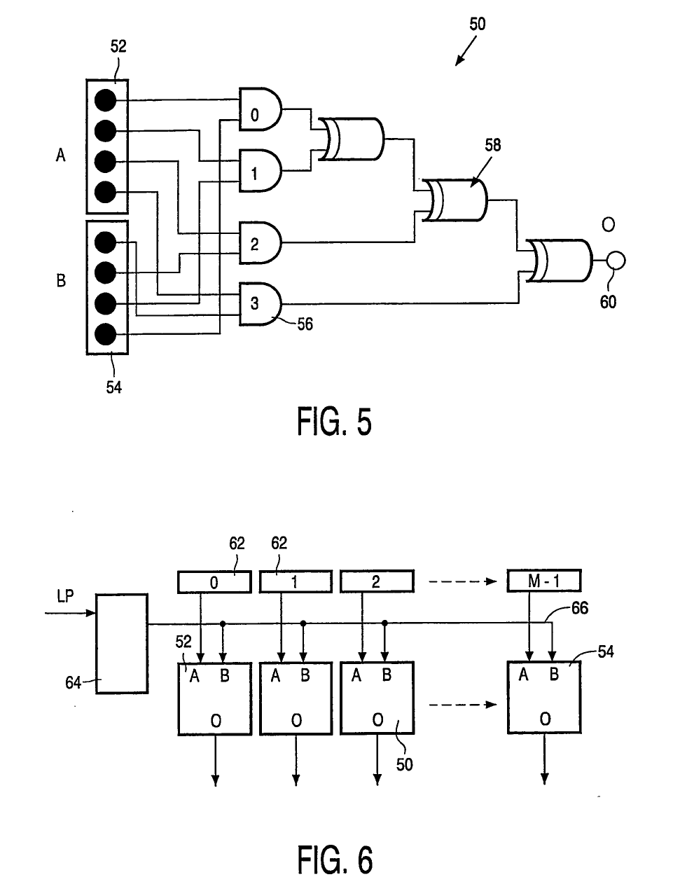

FIG. 5 illustrates a logic circuit incorporated in a basis function generator used in an embodiment of the invention; and

FIG. 6 illustrates the circuit of a basis function generator according to the invention.

There are several transforms that can be used to encode digital data, for example Digital Fourier transforms, Walsh/Hadamard transforms, Haar transforms, or Cosine/Sine transforms.

These transforms allow correlated image data to be represented by a smaller number of uncorrelated data elements in the transform domain. An image may therefore be represented by fewer transform data elements than the original untransformed data.

The general mathematical form of these transforms can be written as

$$\begin{matrix}F ( u ) = {\sum }_{n = 0}^{M - 1} B ( u , n ) f ( n ) & ( 1 ) \\ f ( n ) = \frac{1}{M} {\sum }_{u = 0}^{M - 1} {B}^{- 1} ( u , n ) F ( u ) & ( 2 )\end{matrix}$$

where B(u,n) is a matrix whose rows are the transform basis functions. Equation (1) represents the transform of image data f(n) into transform data F(u) using basis functions B. Equation (2) represents the inverse transform of transform data F(u) into image data f(n) using inverse basis functions B-1. The distinction between transform basis functions and inverse transform basis functions is somewhat arbitrary, and most transforms can operate in either direction. Thus, in the following, both inverse basis functions and basis functions are referred to as basis functions. The skilled person will readily understand which is to be used in any particular case. In particular, for decoding inverse basis functions are generally required, assuming that the original transform is carried out using basis functions. For the transforms listed above it is easy to find B⁻¹, for example the Walsh transform has B⁻¹=B.

FIG. 2 shows basis function examples for Cosine and Walsh transforms for M=8, i.e. for a simplified example with 8 columns. FIG. 2a illustrates example basis functions for the Cosine transform and FIG. 2b for the Walsh transform. The Cosine transform values can take any real value, whereas the Walsh transform basis functions have values that are binary, i.e. have a value of zero or one. Other representations of binary values are also possible; for example the Walsh transform may be represented as a sequence of values each either +1 or −1.

Variable n is the column number and variable u is the transform coefficient number. The f(n) are the original data and F(u) are the transform data.

Consider example original data f(n) with 256 columns, hence 256 different values in one row. In this case M=256. Depending upon the data we may find that there are significantly fewer non-zero F(u) values, say 16, the remaining 240 values being substantially or exactly zero. Thus, the original data can be represented by only 16 F(u) values, resulting in a data reduction factor of 256/16, i.e. 16.

Encoding display lines or large sections of lines in this way can result in very large data reductions, depending upon the data. For example, the output from the word processing application used to write this document could have a loss-less data reduction factor of over 50 for certain lines, especially the blank lines. However, the data reduction will vary considerably between lines.

FIG. 3 illustrates a column driver 30 of a first embodiment of the invention that is able to cope with real-valued basis functions. The basis function generator 32 connects to a series of multipliers 34, there being one multiplier for each column 8. The multipliers multiply the values generated by the basis function generator for each column 8 with the data value input through input 28 for each corresponding column 8. These values are accumulated in accumulator 36 which is made up of memory 38 and adder 40. The outputs of the memory 38 are fed through latches 22, digital-to-analogue converters 24 and buffers 26 to column lines 12 as in the conventional column driver architecture illustrated in FIG. 1.

In use, each row of data to be output on the column lines 12 is processed as follows. Firstly, the memory blocks 38 are cleared. Then, the first item of transform data for the row to be output is input on input 28. The basis function generator 32 generates the values of the basis function for the first set of data and outputs these in parallel to the multipliers 34.

The multipliers then multiply the input transform data which is common to all the columns with the basis function values for each column. In the described embodiment, this multiplication is carried out separately for each column line, and the results stored in memory 38 through adder 40.

The next item of transform data for the row is input to the multipliers 34 from input 28, and the next set of basis function values is output by the basis function generator 32. These values are again multiplied. Adder 40 adds the multiplied values to the contents of memory 38. This repeats until all of the sets of transform data for the current row have been input and summed.

In this way the accumulator 36 formed by memory 38 and adder 40 accumulates the decoded values for output to each column 8, in accordance with equation (2) above.

Then, the latches 22 are operated to pass the accumulated data to the DACs 24, and the voltage buffers 26 to drive the column lines 12. At this time, the row driver 14 is selects the appropriate row 6 of the display to be driven by the outputs of the buffers 26 by driving the corresponding row line 10. The skilled person will appreciate that clock circuitry may be used for synchronising the operation of these various components in a manner well known to the person skilled in the art.

The number of items of transform data for each row may vary depending on the contents of the row. Some rows may be defined by as few as one item—this may be the case for example for a blank line. Other lines with more complete or complex data may require many more items of data. Circuitry or software may be provided to ensure that the basis function generator generates the appropriate set of basis functions for the items of transform data being supplied.

The column driver may be implemented as a single integrated circuit.

In a modification of the above embodiment, a plurality of column drivers may be provided each driving some of the columns of the display. Data input on data input 28 can be distributed amongst the column drivers as required. Control circuitry may be provided to synchronise the different circuits.

It will be appreciated that the arrangement described in FIG. 3 may implement any of the transform techniques previously mentioned. The basis function generator generates different basis functions depending on the transform used. The Cosine transform is the most efficient data encoder for many types of image data, and accordingly this is preferred for some applications.

However, the Walsh transform is preferred in other applications. The Walsh transform has square wave basis functions and is accordingly very suitable for text. It is also easy to implement.

The basis function generator 32 is implemented as a look up table with a memory block 44 storing all the basis function generator and a counter 64 used to address the memory block. An M column display requires a basis function generator giving N outputs for each of M basis functions, and so the memory requires M×M locations. To generate the M basis functions the counter runs from 0 to M−1. Each value of the counter generates in parallel the M values of the basis function corresponding to the value of the counter. This method can be rapid and allows a free choice of basis function. It will be appreciated that in the case that only a small number P of items of transform data are provided for a row, the counter will run from 0 to P−1.

In alternative embodiments the basis function generator 32 may calculate data as required. This has a lower memory requirement. For some transforms, this method requires a lot of multipliers. However, because the Walsh transform has binary basis functions multiplication can be implemented with an XOR, as will be described in more detail below.

It should be noted that the arrangement of the first embodiment can cope with basis functions with binary values, as well as real-valued basis functions, since the multipliers can be arranged to multiply by +1 or −1 by using a representation with basis function values of +1 or −1.

FIG. 4 illustrates an alternative embodiment of a column driver that is adapted for use with basis functions that output binary values. The circuitry is largely the same as that shown in FIG. 3. However, the embodiment of FIG. 4 does not include any multipliers. Instead, the transform data input on input 28 is simply either added to or subtracted from the contents of memory 38 by switch 42 depending on the binary value output by the basis function generator. In this way, the silicon area required for the column driver may be significantly reduced.

FIGS. 5 and 6 illustrate a basis function generator for generating one type of binary valued basis functions, namely Walsh basis functions. A logic circuit 50 is required for each column. FIG. 5 illustrates a 4-bit implementation. The logic circuit has a first four-bit input 52 and a second four-bit input 54, connected to four AND gates 56 and through 3 XOR gates 58 to output 60. The skilled person will readily appreciate how to adapt the logic circuit for a larger number of columns.

The basis function generator 32 is illustrated in FIG. 6. A repeat of logic circuit 50 is provided for each column 8. Each column has its first input 52 hardwired to the IC power and ground lines by constant block 62, which generates a different integer constant in the range [0,M−1] for each column. The second inputs 54 are driven by counter 64 which outputs a series of values to a common data rail 66. The common data rail 66 is connected in parallel to the second inputs 54 of each of the logic circuits. The counter may be clocked by a Phase-locked loop (PLL) controlled by a Line Pulse (LP) signal, or clocked by a separately provided external signal. The M outputs O are the outputs of the basis function generator 32 of FIG. 4.

The arrangement of first and second embodiments may considerably reduce the data flow rate required to be supplied to the column driver. This is of considerable benefit in trying to reduce electromagnetic interference created by very high data rates. It will be noted that the data rate reduction is performed by the use of a transform on sections no longer than a display line. The method is applicable to all display types, including liquid crystal display, active matrix programmable light emitting diode, and other forms of display.

Each pixel element 4 may include a light emitting diode element, or it may be an active pixel element of an active matrix liquid crystal display. It will be appreciated by the skilled person that the invention may be applied to any type of display with a column driver.

From reading the present disclosure, other variations and modifications will be apparent to persons skilled in the art. Such variations and modifications may involve equivalent and other features which are already known in the design, manufacture and use of displays and display drivers and which may be used in addition to or instead of features described herein.

In particular, the separate accumulators and multipliers may be combined and integrated as required. It is convenient to provide the column driver as a single integrated circuit. Alternatively, the column driver may include a plurality of integrated circuits and connection circuitry for connecting and synchronising the plurality of integrated circuits. It will be appreciated by the skilled person that the designations row and column are to some extent arbitrary. Accordingly, the invention includes a column driver as set out above, even if the column driver is arranged at the side of the liquid crystal display and is accordingly generating what is commonly called row data.

1. A column driver for driving a plurality of columns of a display with rows of image data for output on corresponding rows of the display, the column driver comprising:
a basis function generator for generating sets of basis function values and for outputting in parallel a selected set of basis function values for respective columns;
an input for accepting rows of coded transform image data, each row including at least one item of coded transform data;
a plurality of combination units operative to combine the generated set of basis function values for the respective columns with a corresponding input item of coded transform data;
an accumulator associated with each of the columns for accumulating for each row of coded transform image data the data combined by the respective combination unit for each item of coded transform data in turn to accumulate decoded data for the respective column; and
driver circuitry for driving the column lines of the display with the accumulated decoded data for the respective columns to drive a row of the display.

2. A column driver according to claim 1 wherein the combination units are multipliers for multiplying the items of coded transform data with the basis function values for the respective columns.

3. A column driver according to claim 1 wherein the basis function generator includes a memory for storing basis function values and outputting the selected set of basis function values.

4. A column driver according to claim 1 wherein the basis function generator generates basis functions having binary values and each combination unit is a switch for passing the transform data to the corresponding accumulator directly when the basis function value takes one binary value or after inversion when the basis function value takes the other binary value.

5. A column driver according to claim 4 wherein the basis function generator includes a logic circuit associated with each of the columns, the logic circuits each having an input connected to a common data rail and an output for outputting the basis function values for each column based on data supplied on the common data rail.

6. A column driver according to any preceding claim wherein the column driver includes a latch unit on the outputs of the accumulators for latching the decoded rows of data, a digital to analogue converter for converting digital data output by the latch unit to a plurality of analogue values for driving respective column lines, and voltage buffers connected to respective column lines for driving the respective column lines in parallel in accordance with the analogue values output by the digital to analogue converter.

7. A display comprising:
a column driver according to any preceding claim;
a row driver;
a plurality of pixels arranged in a plurality of rows and columns;
a plurality of column lines connected to the column driver; and
a plurality of row lines connected to the row driver.

8. A method of driving the columns of a display with coded transform data, each row of the display being represented by at least one item of data, using a plurality of accumulators associated with a respective plurality of column lines, the method comprising:
clearing the accumulators;
generating a first set of basis data values for respective columns;
combining the first set of coded transform data with the first item in parallel for the plurality of columns;
accumulating the combined data in parallel in the respective accumulators;
repeating for each subsequent items of data of the row the steps of inputting, generating, combining and accumulating to accumulate decoded data in the accumulator; and
driving the column lines of the display with the decoded data.

9. A method according to claim 8 wherein the step of combining consists of multiplying the value of the basis data for the respective column with the item of coded transform data.

10. A method according to claim 8 wherein the step of generating basis function data includes generating sets of basis function data made up of binary values and the step of combining consists of copying the coded transform data to the accumulator when the binary value takes one binary value and inverting and copying the inverted coded transform data to the accumulator when the binary value takes the other binary value.
